(19) United States
(12) Patent Application Publication
(10) Pub. No.: US 2025/0367834 A1
(43) Pub. Date: Dec. 4, 2025

(54) AVATAR AND REMOTE MACHINE OPERATION SYSTEM

(71) Applicant: Mitsubishi Electric Corporation, Tokyo (JP)

(72) Inventors: Masaki HARUNA, Tokyo (JP); Masaki OGINO, Osaka (JP)

(73) Assignee: Mitsubishi Electric Corporation, Tokyo (JP)

(21) Appl. No.: 18/867,450

(22) PCT Filed: May 31, 2023
(86) PCT No.: PCT/JP2023/020387

§ 371 Date: Nov. 20, 2024

(30) Foreign Application Priority Data
Jun. 1, 2022 (JP) 2022-089731

(51) Int. Cl. B25J 11/00; B25J 9/16; B25J 19/02; G06T 13/40

(52) U.S. Cl. CPC B25J 11/0015; B25J 9/1676; B25J 9/1689; B25J 19/023; G06T 13/40

(57) ABSTRACT

An augmented avatar of a remote machine operation system according to the present disclosure is an augmented avatar capable of performing a task via remote control, and includes a communication avatar having a body schema and a manipulation avatar capable of performing the task via the remote control.

### FIELD

The present disclosure relates to an avatar and a remote machine operation system.

### BACKGROUND

Conventional robots can be classified into communication robots, which mainly communicate with a human, and work robots, which perform a task via remote control. Patent Literature 1 discloses a technology for a work robot designed in view also of coexistence with humans. The delivery robot described in Patent Literature 1 includes a display device for communication and a manipulator for performing a task. This delivery robot autonomously delivers meal trays in medical and welfare facilities, and is capable of making simple conversation with a nursing care recipient or with a nursing career by including a touch panel-equipped display and a voice processing device.

### CITATION LIST

### Patent Literature

Patent Literature 1: Japanese Patent Application Laid-open No. H09-267276

### SUMMARY OF INVENTION

### Problem to be Solved by the Invention

The delivery robot described in Patent Literature 1 acts autonomously, thereby having a limitation on actions. However, when a robot is remotely controlled, the robot acts according to an operation of an operator at a remote location, thereby allowing the robot to act diversely. This may prevent a person near the robot from predicting the action of the robot. In this case, a person near the robot may feel uneasy about the action of the robot. It is thus desirable that the operator and a person near the robot have smooth communication via the robot to prevent the person near the robot from feeling uneasy. The technology described in Patent Literature 1 allows a person to make simple conversation with the delivery robot, but does not allow the person near the robot to make conversation with the operator, and moreover, presenting only a monitor image does not provide a sufficient level of nonverbal communication functionality.

The present disclosure has been made in view of the foregoing, and it is an object of the present disclosure to provide an avatar that can provide both smooth communication and a remotely-controlled action.

### Means to Solve the Problem

In order to solve the above-described problems and achieve the object, an avatar according to the present disclosure is an avatar capable of performing a task via remote control, the avatar including: a communication avatar having a body schema; and a remote machine avatar capable of performing the task via the remote control.

### Effects of the Invention

The present disclosure provides an advantage in capability of providing both smooth communication and a remotely-controlled action.

### BRIEF DESCRIPTION OF DRAWINGS

FIG. 1 is a diagram illustrating an exemplary configuration of a remote machine operation system according to a first embodiment.

FIG. 2 is a diagram for schematically describing an augmented avatar of the first embodiment.

FIG. 3 is a diagram illustrating an exemplary configuration of a communication avatar and of a manipulation avatar of the first embodiment.

FIG. 4 is a diagram illustrating an exemplary configuration of a computer system for implementing a control information generation unit of the first embodiment.

FIG. 5 is a diagram illustrating an exemplary configuration of a remote machine operation system according to a second embodiment.

FIG. 6 is a diagram illustrating an example of arrangements of cameras of the second embodiment.

FIG. 7 is a diagram illustrating an exemplary configuration of a remote machine operation system according to a third embodiment.

FIG. 8 is a diagram illustrating an example of an avatar status indication device of the third embodiment.

FIG. 9 is a diagram illustrating an exemplary configuration of a remote machine operation system according to a fourth embodiment.

FIG. 10 is a diagram illustrating an exemplary configuration of a remote machine operation system according to a fifth embodiment.

FIG. 11 is a diagram illustrating an example of operation method used by an operator, of a sixth embodiment.

FIG. 12 is a diagram illustrating an exemplary configuration of an augmented avatar according to a seventh embodiment.

### DESCRIPTION OF EMBODIMENTS

An avatar and a remote machine operation system according to embodiments will be described in detail below with reference to the drawings.

### First Embodiment

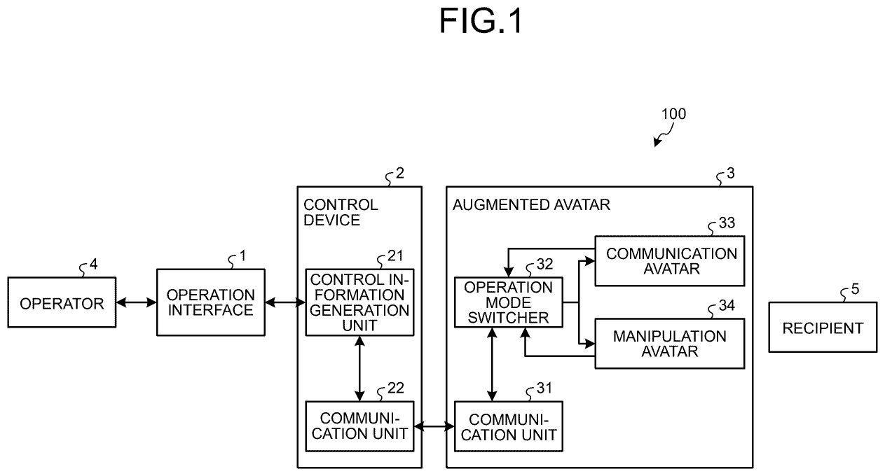

FIG. 1 is a diagram illustrating an exemplary configuration of a remote machine operation system according to a first embodiment. A remote machine operation system 100 of the present embodiment includes an operation interface 1, a control device 2, and an augmented avatar 3, which is an example of an avatar. The augmented avatar 3 is an avatar including a communication avatar 33 and a manipulation avatar 34, which will be described later. The operation interface 1 and the control device 2 are disposed at a first location. The first location is where an operator 4, who remotely controls the augmented avatar 3, is present. The augmented avatar 3 is disposed at a second location, which is a location different from the first location. A recipient 5 is present near the augmented avatar 3. The augmented avatar 3 is capable of performing a task via remote control.

The operator 4 performs an operation using the operation interface 1 to thus remotely control the augmented avatar 3. The operation interface 1 includes, for example, a display device and input means. The display device is, for example, but not limited to, a monitor, a head-mounted display, or the like. The input means may be a device that receives an input by detecting a gesture of the operator 4 on the basis of a moving image showing the operator 4 or on the basis of movement of muscle of the operator 4, or may be a joystick, a touchpad, a button, a keyboard, a mouse, a game controller, or the like. The input means is not limited thereto. Examples of the input means of the operation interface 1 also include a device that receives a voice input such as a microphone.

The control device 2 includes a control information generation unit 21 and a communication unit 22. The control information generation unit 21 generates control information for controlling the augmented avatar 3, 10 on the basis of the input received by the operation interface 1, and outputs the control information generated, to the communication unit 22. In addition, voice of the operator 4 or sound or music associated with an operation of the operator 4 is received by the operation interface 1, 15 passes through the control information generation unit 21, and is then sent to the augmented avatar 3 by the communication unit 22 as control information. Moreover, when the operation interface 1 includes means for obtaining a moving image, the moving image may also pass through the 20 control information generation unit 21, and then be sent to the augmented avatar 3 by the communication unit 22 as control information. Note that information representing a moving image and a sound may be sent to the augmented avatar 3 by the communication unit 22 as moving image information and as voice information separately from the control information without passing through the control information generation unit 21, or when the operation interface 1 has communication functionality, information representing a moving image and a sound may be sent from 30 the operation interface 1 directly to the augmented avatar 3.

An operation of the operator 4 is converted into an expression, a sound output, a motion, and/or the like of the augmented avatar 3. Not only a motion of the augmented avatar 3, but also an expression and a sound output of the augmented avatar 3 are hereinafter referred to collectively as action of the augmented avatar 3. The control information generation unit 21 holds mapping information, which represents a mapping between an operation of the operator 4 and an action of the augmented avatar 3. On the basis of the mapping information, the control information generation unit 21 generates control information from the operation received by the operation interface 1. In addition, the present embodiment assumes that the operator 4 performs an operation of setting an operation mode, and the control information generation unit 21 further generates, as the control information, information representing the operation mode that has been set. The operation mode is a mode indicating in which of the communication avatar 33 or the manipulation avatar 34 (each described later) an operation using a particular part, such as a hand, of the operator 4 is to be reflected. The operation mode will be described in detail later. The mapping information may be changeable through an operation of the operator 4. Although an example will herein be described in which the control device 2 generates control information representing an action associated with the operation of the operator 4, the configuration is not limited to this example. An operation mode switcher 32, described later, may generate control information representing an action associated with an operation of the operator 4. In this case, the operation mode switcher 32 holds the mapping information. Moreover, the configuration is not limited to the configuration of the example illustrated in FIG. 1. The control information generation unit 21 and the operation mode switcher 32 may be disposed in the augmented avatar 3 or in the operation interface 1. In addition, the mapping information may be separately held in the control information generation unit 21 and in the operation mode switcher 32. For example, the operation mode switcher 32 may hold the mapping information that may vary depending on the operation mode, while the control information generation unit 21 may hold the mapping information that is independent of the operation mode. The method of holding the mapping information is not limited to this example.

The communication unit 22 communicates with the augmented avatar 3. Specifically, the communication unit 22 sends the control information generated by the control information generation unit 21 to the augmented avatar 3, and outputs information received from the augmented avatar 3 to the control information generation unit 21. The augmented avatar 3 and the control device 2 communicate with each other using a communication line, which may be a wireless line, a wired line, or a combination of a wireless line and a wired line. For example, the communication line between the augmented avatar 3 and the control device 2 may be a communication line of a communication scheme such as a fifth generation (5G) or Beyond 5G mobile communication system, which provides high-capacity low-latency transmission, or may be a communication line of another communication scheme.

The augmented avatar 3 includes a communication unit 31, the operation mode switcher 32, the communication avatar 33, and the manipulation avatar 34. The communication unit 31 communicates with the control device 2. The operation mode switcher 32 switches the operation mode from one to another on the basis of the control information received from the control device 2 via the communication unit 31, and notifies either the communication avatar 33 or the manipulation avatar 34 depending on the operation mode, of the control information.

The communication avatar 33 is an avatar having a body schema, and has communication functionality. The phrase “to have a body schema” means, for example, to include a concrete member imitating at least part of a human or animal body such as head, waist, arms, and/or legs, at least one of which is driven. The member imitating at least part of a body is a physically existing member, and may even be extremely deformed.

The manipulation avatar 34 is an example of a remote machine avatar capable of performing a task via remote control. The manipulation avatar 34 includes, for example, a manipulator, and is movable. Note that although an avatar including a manipulator is herein given as an example of a remote machine avatar by way of example, the remote machine avatar is not limited thereto. The remote machine avatar may be a machine that is movable such as a vehicle, or may be a machine including a manipulator and incapable of moving. For example, the remote machine avatar may be a machine such as a mecanum wheel or omni wheel omnidirectional mobile machine, a two-wheeled mobile machine, a legged mobile machine, or a composite machine having a combination of these features. Note that although an example will be described herein in which the manipulation avatar 34, i.e., the remote machine avatar, is capable of moving (i.e., has a mechanism for moving), and the communication avatar 33 moves together with the manipulation avatar 34, the configuration is not limited to this example. The configuration may be such that the communication avatar 33 is capable of moving, and the manipulation avatar 34 moves together with the communication avatar 33. Alternatively, both the manipulation avatar 34 and the communication avatar 33 may be capable of moving.

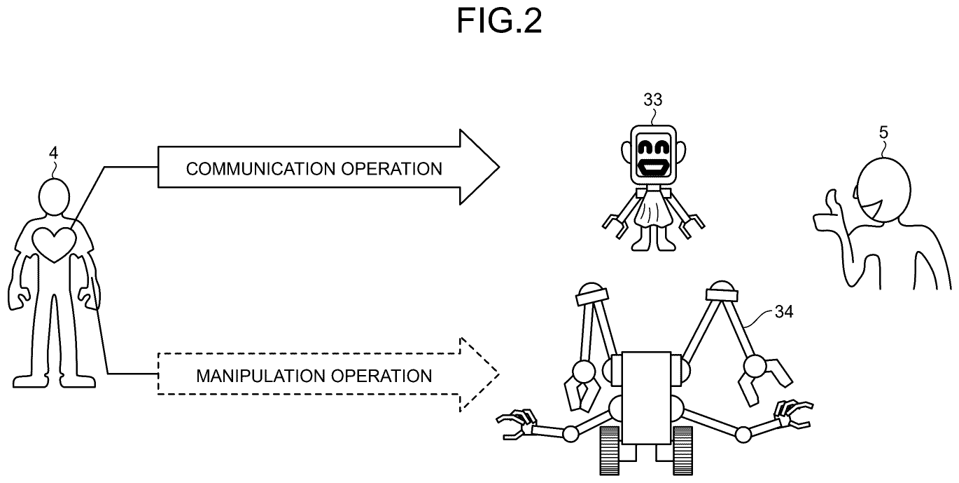

In the present embodiment, the augmented avatar 3 includes the communication avatar 33 and the manipulation avatar 34 as described above. FIG. 2 is a diagram for schematically describing the augmented avatar 3 of the present embodiment. The manipulation avatar 34 may perform, for example, daily life activities such as playing a game, taking a meal, exchanging business cards, picking up a thing on a table, opening a door, using an intercom, and/or going out to buy something, or may perform not only a task of carrying a load, but also a cooperative task to be performed in cooperation with a person, and/or a task difficult to be performed only by humans. In addition, the manipulation avatar 34 may include a camera for shooting to perform shooting, and/or may be a vehicle that can carry humans. The tasks to be performed by the manipulation avatar 34 are not limited to these.

As illustrated in FIG. 2, the manipulation avatar 34 acts according to a hand operation (i.e., manipulation operation) of the operator 4, and is thereby capable of performing a task or the like. Meanwhile, facial expression, voice, and the like of the operator 4 are each transferred to the communication avatar 33 as communication operation, and the communication avatar 33 then presents the facial expression, voice, and the like of the operator 4 to the recipient 5. This allows the recipient 5 to recognize the action of the manipulation avatar 34 while communicating with the communication avatar 33, and enables an uneasy feeling to be reduced when the manipulation avatar 34 makes a big action. The manipulation avatar 34 is designed to have a form suitable for intended task, and may cause the recipient 5 to feel an oppressive feeling through a big action, a weighty appearance, and/or the like of the manipulation avatar 34. By designing the communication avatar 33 to mitigate a feeling of fear or an uneasy feeling, for example, through use of a smaller size than the size of the manipulation avatar 34, of a material giving a soft impression, of a member having an at least partly rounded shape, or of a wood material, the augmented avatar 3 can reduce an uneasy feeling of the recipient 5, thereby enabling smooth communication to be made more easily.

In addition, owing to inclusion of a driven part, the communication avatar 33 can engage in not only verbal communication but also nonverbal communication. FIG. 2 illustrates the communication avatar 33 as having arms and legs, and the arms are movable according to an operation of the operator 4. In the present embodiment, the operation mode includes, for example, a communication operation mode, in which a hand motion of the operator 4 is transferred to the communication avatar 33, and a manipulation operation mode, in which an arm or hand motion of the operator 4 is transferred to the manipulation avatar 34. These two operation modes can be switched from one to another according to the operation of the operator 4. For example, an arm or hand motion of the operator 4 is reflected in an action of the communication avatar 33 in the communication operation mode, while a hand motion of the operator 4 is reflected in an action of the manipulation avatar 34 in the manipulation operation mode.

Meanwhile, driven units, such as the arms, of the communication avatar 33 become no longer movable when a hand motion is reflected in an action of the manipulation avatar 34 in the manipulation operation mode, but driven units of the communication avatar 33 may be made movable even in the manipulation operation mode by use of a mapping to cause the arms of the communication avatar 33 to move according to the expression of the operator 4. Note that information necessary for verbal communication such as voice is reflected in an action of the communication avatar 33 also in the manipulation operation mode, but the operation is not limited thereto. The function of verbal communication may also be inactivated in the manipulation operation mode. Reflecting information necessary for verbal communication, such as voice, in an action of the communication avatar 33 also in the manipulation operation mode enables the manipulation avatar 34 to perform a task while, for example, the recipient 5 and the communication avatar 33 make conversation.

In addition, the communication avatar 33 may be capable of driving not only the arms but also the legs to allow an operation using a leg of the operator 4 to be reflected in a leg action of the communication avatar 33. Moreover, an operation using an arm or a hand of the operator 4 may be reflected in a leg action of the communication avatar 33. Thus, a mapping (correspondence) representing what operation of the operator 4 corresponds to what action of the communication avatar 33 can be set arbitrarily. Furthermore, the communication avatar 33 may include a member that can be driven and imitates a tail or the like, and an operation using a hand or leg of the operator 4 may be reflected in a motion of this member. Mapping information representing this mapping may be held, as described above, in the control information generation unit 21 of the control device 2 or in the operation mode switcher 32 of the augmented avatar 3.

Note that when the manipulation avatar 34 is a mobile machine, making a space in the manipulation avatar 34 for enabling the communication avatar 33 to be placed thereon will enable the communication avatar 33 and the manipulation avatar 34 to be moved integrally. In this case, the space for enabling the communication avatar 33 to be placed thereon can be provided at any position of the manipulation avatar 34. For example, when the communication avatar 33 that can be driven is integrated with the manipulation avatar 34 to form a robot arm shape, a hand end portion thereof can be used for gesture of the communication avatar 33 and also used as a hand for grasping an object by the manipulation avatar 34.

In addition, the operation of the operator 4 is not limited to a physical operation, but may be voice, tone, facial expression, or the like. For example, the communication avatar 33 may be caused to act according to a feeling of the operator 4 determined based on at least one of voice, tone, facial expression, and biological information such as a brain wave. For example, the operation interface 1 may include a camera, and the control information generation unit 21 of the control device 2 may perform image analysis on a moving image of the operator 4 captured by the camera to determine a feeling of the operator 4 on the basis of the facial expression of the operator 4, and generate the control information for causing the communication avatar 33 to act, using information representing a predetermined mapping between feelings of the operator 4 and actions of the communication avatar 33.

In addition, color and/or clothing of the communication avatar 33 may be changed according to the feeling of the operator 4 or according to the operation of the operator 4. Specifically, at least one of color and clothing of the communication avatar 33 can be changed by changing the moving image to be displayed on the communication avatar 33 according to, for example, at least one of an operation status and a feeling expressed by the operator 4. For example, a display unit 332 (described later) of the communication avatar 33 may be further provided at a position other than a position corresponding to the head to display the color and/or clothing, or the color and/or clothing may be displayed using a technique such as projection mapping.

For example, the color of the communication avatar 33 may be changed, for example, to red when an error has occurred, to emerald green when the operator 4 is in a good mood, and to black to express discouragement. Correspondence between the colors and the situations to be expressed is not limited to this example. Moreover, a video projection device capable of presenting a video onto an area near the augmented avatar 3 may be provided to project words said by the augmented avatar 3, the travel direction of the augmented avatar 3, a document to be provided by the augmented avatar 3, or the like on a table or on the floor using a balloon, an arrow, letters, a moving image, or the like, according to the operation of the operator 4. That is, the augmented avatar 3 may project at least one of words said by the augmented avatar 3, the travel direction of the augmented avatar 3, and a document provided by the augmented avatar 3, onto an area near the avatar.

Note that the foregoing example has been described in which the recipient 5 is present near the augmented avatar 3, but the remote machine operation system 100 of the present embodiment can also be used when the recipient 5 is not present near the augmented avatar 3. For example, when the manipulation avatar 34 is a device that performs shooting for broadcasting or streaming, the operator 4 may use the communication avatar 33 to send voice, as a reporter or the like does, to a viewer who views the broadcast program or a viewer who views the recorded video to communicate with the viewer. In this case, the viewer is the recipient 5.

In the present embodiment, inclusion of the communication avatar 33 and the manipulation avatar 34 enables a system to be established flexibly depending on the situation or usage, and also enables verbal and nonverbal communication to be smoothly made. In addition, the configuration of the present embodiment allows the communication avatar 33 and the manipulation avatar 34 to be separately designed, and thereafter to be integrated to form a single augmented avatar 3. This can increase efficiency in designing and producing, and can provide cost reduction. For example, when the communication avatar 33 is standardized for multiple usages, and the manipulation avatar 34 is individually designed according to the task to be performed, cost can be reduced by standardization of the communication avatar 33, and the manipulation avatar 34 is no more required to have communication functionality, thereby enabling efficiency to be increased in designing and producing, and cost to be reduced.

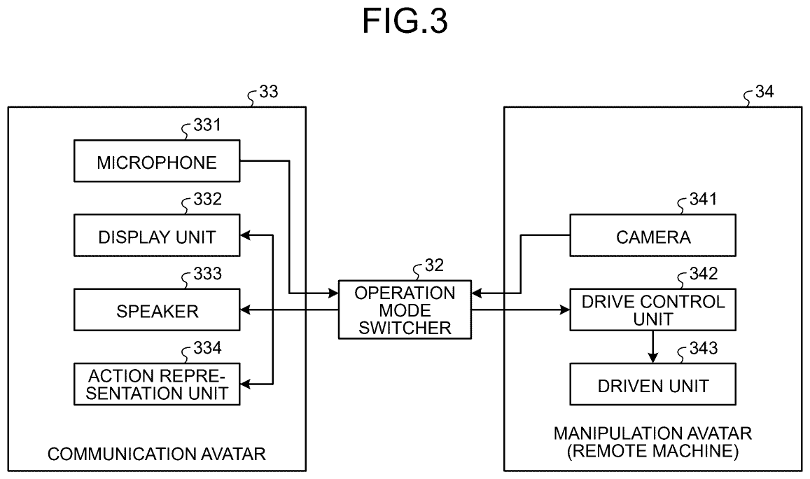

FIG. 3 is a diagram illustrating an exemplary configuration of the communication avatar 33 and the manipulation avatar 34 of the present embodiment. The communication avatar 33 includes, for example, a microphone 331, a display unit 332, a speaker 333, and an action representation unit 334.

A sound collected by the microphone 331 is sent to the control device 2 via the operation mode switcher 32 and the communication unit 31. The control device 2 outputs the sound collected by the microphone 331 to the operation interface 1, thereby enabling the operator 4 to hear the sound collected by the microphone 331. The display unit 332, the speaker 333, and the action representation unit 334 operate on the basis of the control information (or moving image information or voice information) received from the control device 2. The display unit 332 is a monitor or the like. On the display unit 332, a moving image showing the operator 4 may be displayed, or letters, a figure, or a moving image associated with the operation of the operator 4 may be displayed. The display unit 332 may be provided two or more in number. The speaker 333 may output a voice of the operator 4 or output a sound, music, or the like associated with the operation of the operator 4. The action representation unit 334 corresponds to, for example, a part that can be driven and imitates at least part of a body, and includes a driven unit and a drive control unit, which require less currents than currents of a drive control unit 342 and of a driven unit 343 of the manipulation avatar 34 described later.

Note that although FIG. 3 illustrates an example in which the communication avatar 33 includes the display unit 332, the communication avatar 33 does not need to include the display unit 332. It is sufficient that the communication avatar 33 include the microphone 331, the speaker 333, and the action representation unit 334. The microphone 331 and the speaker 333 serve as an example of a verbal communication unit to make verbal communication. The action representation unit 334 is an example of a portion that can be driven and imitates at least part of a human or animal body.

The manipulation avatar 34 includes a camera 341, the drive control unit 342, and the driven unit 343. The camera 341 captures a moving image of surroundings of the manipulation avatar 34. The moving image captured by the camera 341 is sent to the control device 2 via the operation mode switcher 32 and the communication unit 31. The drive control unit 342 controls the driven unit 343 on the basis of the control information received via the communication unit 31 and the operation mode switcher 32. The driven unit 343 is, for example, a motor of a manipulator, a motor for driving wheels for moving, or the like. The driven unit 343 typically requires a high current, whose current value is greater than the current value required by the action representation unit 334 of the communication avatar 33. Note that the manipulation avatar 34 may further include some types of sensors and/or the like in addition to the components illustrated in FIG. 3.

Note that the augmented avatar 3 of the present embodiment may be able to be housed in a container such as, for example, a suitcase, a bag, or a wheeled box for portability. For example, the augmented avatar 3 may be configured to be housed in a container, and quickly expandable at the time of operation. That is, the augmented avatar 3 may be foldable to be housed in a container, and become operable by expansion. In addition, the container may be used as part of the augmented avatar 3. That is, the augmented avatar 3 may be configured, for example, to automatically expand when the container is opened, or expand when the container is opened and predetermined input means such as a button or a switch is operated, at the time of operation. Alternatively, the augmented avatar 3 may be manually expanded. The augmented avatar 3 may be housed into a container manually or by operation of input means such as, for example, a button or a switch to fold and deform the augmented avatar for housing.

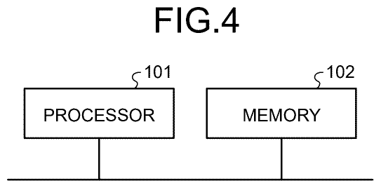

A hardware configuration of the present embodiment will next be described. Regarding the control information generation unit 21 of the control device 2 of the present embodiment, a program (computer program) that describes processing to be performed in the control information generation unit 21 is executed in processing circuitry, which is a computer system, thereby causing the computer system to function as the control device 2. FIG. 4 is a diagram illustrating an exemplary configuration of a computer system for implementing the control information generation unit 21 of the present embodiment. As illustrated in FIG. 4, this computer system includes a processor 101 and a memory 102.

In FIG. 4, the processor 101 is, for example, a processor such as a central processing unit (CPU), and executes a program that describes processing to be performed in the control information generation unit 21 of the present embodiment. The memory 102 includes various types of memories such as a random access memory (RAM) and/or a read-only memory (ROM) and a storage device such as a hard disk. The memory 102 stores a program to be executed by the processor 101 described above, necessary data obtained during processing, and the like. In addition, the memory 102 is also used as a temporary storage area for a program.

An exemplary operation of the computer system until a program of the present embodiment becomes executable will next be described. The program is installed into the memory 102 of the computer system configured as described above from, for example, a compact disc (CD)-ROM or a digital versatile disc (DVD)-ROM placed in a CD-ROM drive or a DVD-ROM drive (each not illustrated). Then, upon execution of the program, the program read from the memory 102 is loaded into a main storage area of the memory 102. In this state, the processor 101 performs processing to function as the control information generation unit 21 of the present embodiment, according to the program loaded into the memory 102.

Note that although the foregoing description has described that the program describing processing to be performed in the control information generation unit 21 is provided using a CD-ROM or a DVD-ROM as a recording medium, the method of program delivery is not limited thereto. A program provided using, for example, a transmission medium such as the Internet may be used, depending on the configuration of the computer system, the size of the program to be provided, and/or the like.

As described above, the augmented avatar 3 of the present embodiment includes the communication avatar 33 and the manipulation avatar 34. Thus, the augmented avatar 3 enables a system to be established flexibly depending on the situation or usage, and also enables verbal and nonverbal communication to be smoothly made.

### Second Embodiment

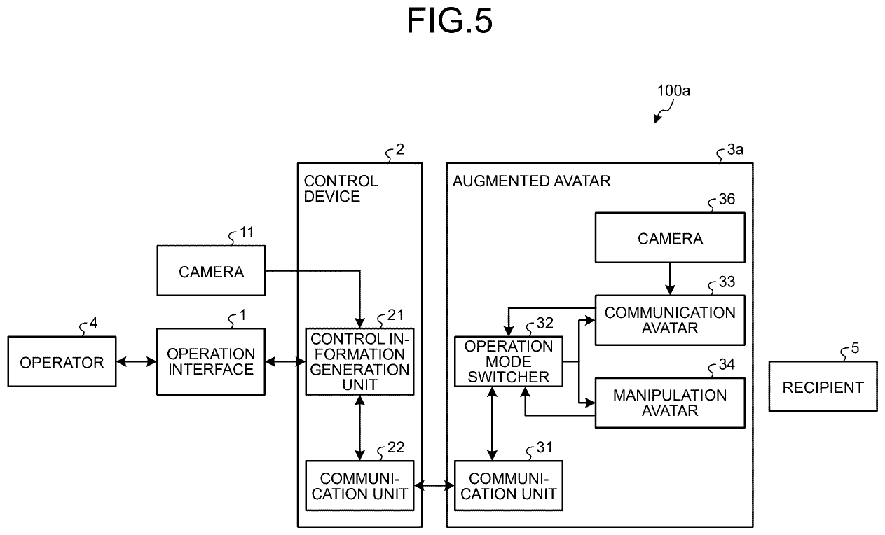

FIG. 5 is a diagram illustrating an exemplary configuration of a remote machine operation system according to a second embodiment. A remote machine operation system 100a of the present embodiment is similar to the remote machine operation system 100 of the first embodiment except including an augmented avatar 3a in place of the augmented avatar 3 and additionally including a camera 11. Components having functionality similar to the functionality of the first embodiment are designated by reference characters the same as corresponding ones of the first embodiment, and duplicate description will be omitted. The following description will primarily describe differences from the first embodiment.

The camera 11 is installed at a first location, and captures a moving image of the operator 4 to include the face of the operator 4 in the moving image. In the present embodiment, the operation interface 1 includes a display device such as a monitor, and the camera 11 is disposed, for example, on the display device or in a vicinity of the display device, in such an orientation that allows shooting of the front side of the operator 4. A moving image captured by the camera 11 passes through the control information generation unit 21, is sent from the communication unit 22 to the augmented avatar 3a, and is then displayed on the display unit 332 of the augmented avatar 3a.

The augmented avatar 3a additionally includes a camera 36 as compared to the augmented avatar 3 of the first embodiment. The camera 36 is disposed on the display unit 332 or in a vicinity of the display unit 332, in such an orientation that allows the recipient 5 to be shot from the front, who is making conversation while checking the display unit 332 in the augmented avatar 3a. A moving image captured by the camera 36 passes through the operation mode switcher 32, is sent from the communication unit 31 to the control device 2, passes through the control device 2, and is then displayed on the display device of the operation interface 1.

In the present embodiment, the face of the operator 4 is shot to allow the operator 4 and the recipient 5 to make conversation while facing each other, thereby enabling conversation to be made in eye-to-eye contact. In particular, disposing the camera 11 and the camera 36 in the rear of the monitors to allow the operator 4 and the recipient 5 to easily make eye contact with each other allows the operator 4 and the recipient 5 to easily make eye contact with each other, thereby enabling verbal and nonverbal communication to be made in eye-to-eye contact, and communication to be made more smoothly.

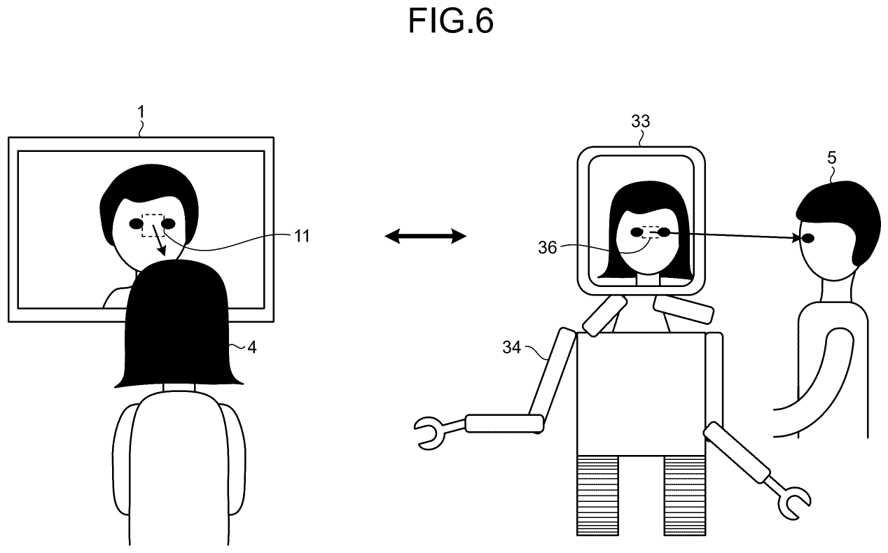

FIG. 6 is a diagram illustrating an example of arrangements of the cameras 11 and 36 of the present embodiment. In the example illustrated in FIG. 6, the camera 11 is disposed in the rear of a monitor that is part of the operation interface 1, and the camera 36 is disposed in the rear of a monitor that is the display unit 332 of the communication avatar 33 of the augmented avatar 3a. In addition, a hole is formed on a projection surface of each of the monitors to allow the cameras 11 and 36 disposed in the rear to shoot the operator 4 and the recipient 5 through the respective holes. Alternatively, instead of forming holes, the projection surface of each of the monitors may be formed as a half mirror to allow shooting from the rear. This allows the operator 4 and the recipient 5 to make eye contact with each other. The cameras 11 and 36 may each be provided two or more in number.

Note that matching the positions of the cameras 11 and 36 with positions of the eyes of the recipient 5 and the operator 4 in the projected moving images will allow the recipient 5 and the operator 4 to make eye contact with each other more easily. Accordingly, the positions of the projected moving images may be adjusted using a technique such as face recognition processing to match the positions of the eyes in the projected moving images with the positions of the cameras 11 and 36. In addition, there may be a case where the positions of the cameras 11 and 36 are inappropriate depending on the positions or postures of the operator 4 and the recipient 5, and accordingly, the positions of the cameras 11 and 36 may be adjusted to match the positions of the eyes by adjusting the height of the chair or stool or adjusting the height of the monitor by the operator 4 and/or the recipient 5. Alternatively, the operation interface 1 may be configured in which multiple holes are formed in the monitor thereof, the camera 11 is provided correspondingly to each of the holes, and the operator 4 selects the camera 11 to be used. The communication avatar 33 may be configured similarly in which multiple holes are formed in the monitor thereof, the camera 36 is provided correspondingly to each of the holes, and the recipient 5 selects the camera 36 to be used. Still alternatively, the operation interface 1 may be configured in which multiple holes are formed in the monitor thereof, a mechanism for moving the camera 11 is provided, and the operator 4 selects the position of the camera 11. The communication avatar 33 may be configured similarly in which multiple holes are formed in the monitor of the communication avatar 33, a mechanism for moving the camera 36 is provided, and the recipient 5 selects the position of the camera 36. The operator 4 and the recipient 5 may select, on the basis of the projected moving images, the cameras 11 and 36 to be used to make eye contact easily, without adjustment of the positions of the eyes in the projected moving images to the positions of the cameras 11 and 36. Also when a half mirror is used, the cameras 11 and 36 may similarly each be provided in multiple positions, or be made movable. Moreover, cameras embedded inside the monitors may be used as the cameras 11 and 36.

As described above, the communication avatar 33 includes a first monitor, which is enabled to display a first moving image showing an operator who performs remote control, and the camera 36, which is a first camera that is provided in the rear of the first monitor and enabled to shoot in the direction toward the projection surface of the first monitor, from the rear of the first monitor. The first moving image is a moving image obtained by shooting in the direction toward the projection surface of a second monitor by the camera 11 (i.e., moving image of the operator 4), where the camera 11 is a second camera provided in the rear of the second monitor, which is enabled to present, to the operator 4, a second moving image captured by the camera 36 (i.e., moving image of the recipient 5), where the camera 36 is the first camera.

In addition, when the manipulation avatar 34 includes the camera 341, a moving image obtained by the camera 341 and a moving image obtained by the camera 36 of the communication avatar 33 may be switched from one to another according to the operation mode to cause a selected one to be displayed on the monitor of the operation interface 1. Alternatively, when the manipulation avatar 34 includes the camera 341, a moving image obtained by the camera 341 and a moving image obtained by the camera 36 of the communication avatar 33 may be simultaneously displayed on the monitor of the operation interface 1.

As described above, in the present embodiment, the cameras 11 and 36 are disposed in the rear of the monitors. This allows the operator 4 and the recipient 5 to make eye contact easily, thereby enabling verbal and nonverbal communication to be made in eye-to-eye contact, and communication to be made more smoothly.

### Third Embodiment

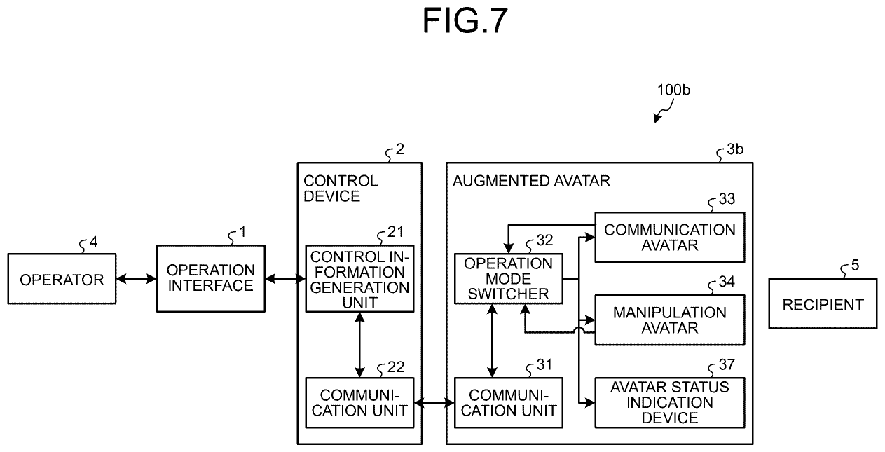

FIG. 7 is a diagram illustrating an exemplary configuration of a remote machine operation system according to a third embodiment. A remote machine operation system 100b of the present embodiment is similar to the remote machine operation system 100 of the first embodiment except including an augmented avatar 3b in place of the augmented avatar 3. Components having functionality similar to the functionality of the first embodiment are designated by reference characters the same as corresponding ones of the first embodiment, and duplicate description will be omitted. The following description will primarily describe differences from the first embodiment.

The augmented avatar 3b additionally includes an avatar status indication device 37 as compared to the augmented avatar 3 of the first embodiment. The operation mode switcher 32 determines the operation mode on the basis of the control information received from the control device 2, and causes the avatar status indication device 37 to provide indication dependent on the operation mode, according to a result of determination of the operation mode.

The avatar status indication device 37 is a status indication device that indicates which one of the communication avatar 33 and the manipulation avatar 34 performs an action. In more detail, the avatar status indication device 37 is a display device that indicates the operation mode. The avatar status indication device 37 may be a single indicator or a set of multiple indicators. When the avatar status indication device 37 is a single indicator, the avatar status indication device 37 represents, for example, a color, a figure, a letter, a moving image, and/or the like indicating the operation mode. Alternatively, the avatar status indication device 37 may include two indicators respectively provided on the communication avatar 33 and the manipulation avatar 34. In this case, for example, the indicator provided on the communication avatar 33 is illuminated in the communication operation mode, while the indicator provided on the manipulation avatar 34 is illuminated in the manipulation operation mode.

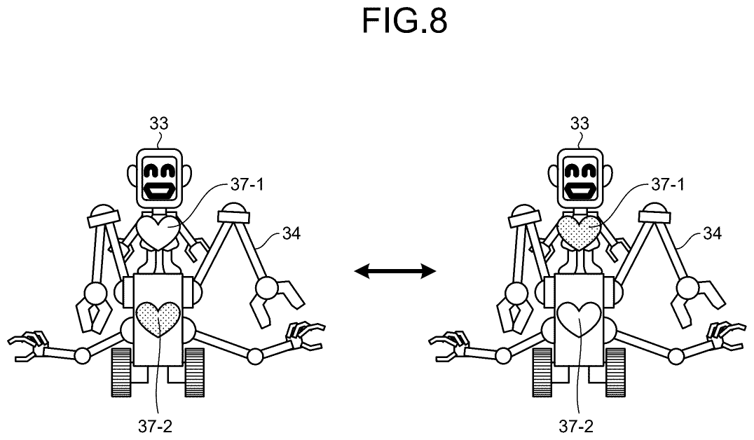

FIG. 8 is a diagram illustrating an example of the avatar status indication device 37 of the present embodiment. The example illustrated in FIG. 8 assumes that the avatar status indication device 37 includes an indicator 37-1 provided on the communication avatar 33 and an indicator 37-2 provided on the manipulation avatar 34. The left image of FIG. 8 illustrates a case of the manipulation operation mode, in which the indicator 37-2 is illuminated and the indicator 37-1 is turned off. The right image of FIG. 8 illustrates a case of the communication operation mode, in which the indicator 37-1 is illuminated and the indicator 37-2 is turned off. Note that the shapes of the indicators 37-1 and 37-2 are not limited to the shapes of the example illustrated in FIG. 8.

Note that although the above example has been described in which the avatar status indication device 37 is added to the remote machine operation system 100 of the first embodiment, the avatar status indication device 37 may be added to the remote machine operation system 100a of the second embodiment to implement indication of the operation mode similarly.

In the present embodiment, the operation mode is indicated using the avatar status indication device 37, thereby enabling an explicit indication to be provided to the recipient 5, regarding which avatar of the communication avatar 33 and the manipulation avatar 34 performs an action. This enables the recipient 5 to easily predict the action of the augmented avatar 3b, and to make communication without anxiety.

### Fourth Embodiment

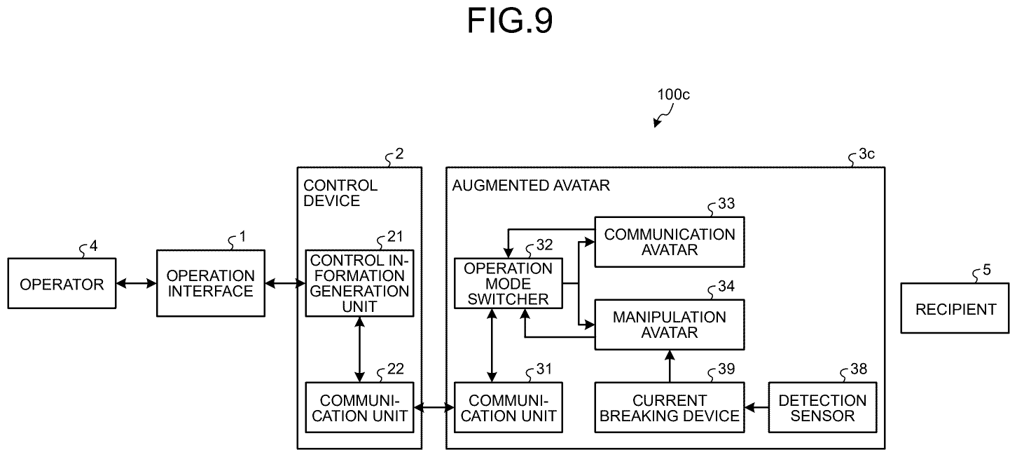

FIG. 9 is a diagram illustrating an exemplary configuration of a remote machine operation system according to a fourth embodiment. A remote machine operation system 100c of the present embodiment is similar to the remote machine operation system 100 of the first embodiment except including an augmented avatar 3c in place of the augmented avatar 3. Components having functionality similar to the functionality of the first embodiment are designated by reference characters the same as corresponding ones of the first embodiment, and duplicate description will be omitted. The following description will primarily describe differences from the first embodiment.

The augmented avatar 3c additionally includes a detection sensor 38 and a current breaking device 39 as compared to the augmented avatar 3 of the first embodiment. The detection sensor 38 checks for presence of an obstruction that is a person or object near the augmented avatar 3c, and when an obstruction is detected, informs the current breaking device 39 that an obstruction has been detected. For example, when the distance between the obstruction and the augmented avatar 3c reaches or falls less than or equal to a threshold, the detection sensor 38 informs the current breaking device 39 that an obstruction has been detected. Upon reception of the notification that an obstruction has been detected, the current breaking device 39 interrupts current supplied from the drive control unit 342 to the driven unit 343 in the manipulation avatar 34 to thereby stop the action of the driven unit 343. That is, when an obstruction is detected that is present at a distance from the augmented avatar 3c less than or equal to a threshold, the current breaking device 39 interrupts the current of a drive system in the manipulation avatar 34. In contrast to the communication avatar 33, which is designed to create no problem even upon contact with a person, the manipulation avatar 34 may sometimes use a drive system that can provide a high power output, as the drive control unit 342 and the driven unit 343. Avoiding coming into contact with the recipient 5 is therefore desirable. In the present embodiment, the manipulation avatar 34 can be stopped performing an action when the recipient 5 is present in a vicinity of the augmented avatar 3c. Accordingly, the manipulation avatar 34 can avoid coming into contact with the recipient 5. Moreover, even when the recipient 5 is present near the augmented avatar 3, the manipulation avatar 34 may be allowed to be driven when the operator 4 is given a permission to cause the manipulation avatar 34 to perform an action, from the recipient 5 via the augmented avatar 3.

Note that although the above example has been described in which the detection sensor 38 and the current breaking device 39 are added to the remote machine operation system 100 of the first embodiment, the detection sensor 38 and the current breaking device 39 may be added to the remote machine operation systems 100a and 100b of the second and third embodiments to implement indication of the operation mode similarly.

### Fifth Embodiment

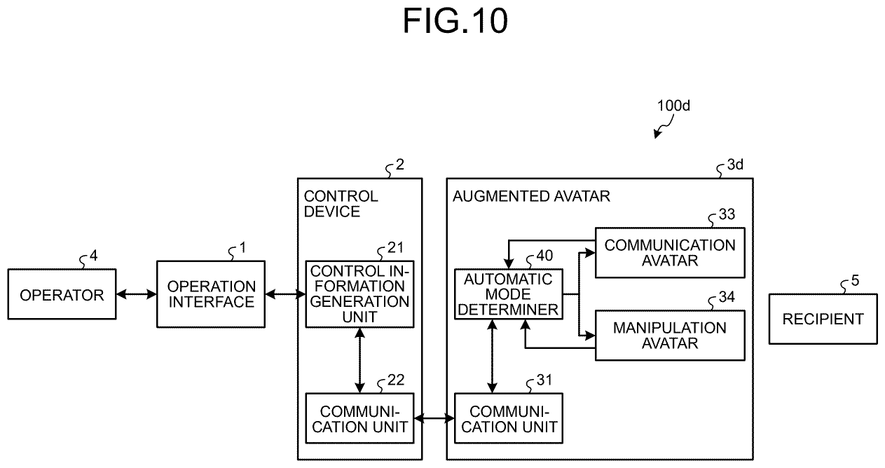

FIG. 10 is a diagram illustrating an exemplary configuration of a remote machine operation system according to a fifth embodiment. A remote machine operation system 100d of the present embodiment is similar to the remote machine operation system 100 of the first embodiment except including an augmented avatar 3d in place of the augmented avatar 3. Components having functionality similar to the functionality of the first embodiment are designated by reference characters the same as corresponding ones of the first embodiment, and duplicate description will be omitted. The following description will primarily describe differences from the first embodiment.

The augmented avatar 3d includes an automatic mode determiner 40 in place of the operation mode switcher 32 of the first embodiment. In contrast to the first embodiment, in which the operation mode is switched from one to another through an operation of the operator 4, the automatic mode determiner 40 in the present embodiment automatically switches the operation mode according to the situation. For example, the automatic mode determiner 40 may determine a frequency of conversation on the basis of exchanges of voice information, and may switch the operation mode from one to another according to the frequency of conversation. Alternatively, operations performed by the operator 4 may each be automatically allocated to a command value directed to a corresponding one of the communication avatar 33 and the manipulation avatar 34. That is, the automatic mode determiner 40 is an operation allocation device that allocates an operation of the operator 4 who performs remote control to a command value directed to either the communication avatar 33 or the manipulation avatar 34. One example of operation allocation is to allocate operations to command values of only one of the communication avatar 33 and the manipulation avatar 34, which case corresponds to switching of the operation mode. Note that FIG. 10 illustrates the automatic mode determiner 40, which is the operation allocation device, as being disposed inside the augmented avatar 3d, but the configuration is not limited thereto. The automatic mode determiner 40 may be disposed inside the control device 2. For example, the inside of the control information generation unit 21 may also have functionality of the automatic mode determiner 40. Alternatively, the automatic mode determiner 40 may be disposed separately from the augmented avatar 3d and the control device 2.

In this example, a command value (setting value) is, for example, a value for determining an action of a corresponding one of the communication avatar 33 and the manipulation avatar 34, and represents, for example, but not limited to, a driven range of an arm of the manipulation avatar 34, a weight of an object to be handled, or the like. In addition, when the manipulation avatar 34 has two or more arms, and these arms have different hand shapes, not only a weight of an object to be handled, but also the shape of the object to be handled is represented by a command value (setting value).

A command value (setting value) is set, for example, through one or a combination of two or more of the following methods.
The operator 4 previously sets a correspondence between command value-related information and allocation information. The command value-related information is information for determining a command value, and the allocation information is information representing a ratio for use in command value allocation. The command value-related information is, for example, but not limited to, one or more of the frequency of conversation between the operator 4 and the recipient 5, the content of the conversation, the type of action of the manipulation avatar 34, and the like. The allocation information is, for example, but not limited to, a weighting factor representing a weight, or may be a ratio for use in allocation. Alternatively, the operator 4 may directly set a ratio for use in the command value allocation.
Values previously registered in the communication avatar 33 and the manipulation avatar 34 are each used as a command value (setting value). Otherwise, the allocation information is previously registered in the communication avatar 33 and the manipulation avatar 34, and a command value (setting value) is determined on the basis of the allocation information.
Information representing the ratio for use in allocation is obtained by learning while the operator 4 uses the augmented avatar 3d for operation. For example, instead of using functionality of automatic operation allocation, the operator 4 performs operation of setting a command value directed to either the communication avatar 33 or the manipulation avatar 34, depending on the situation. The automatic mode determiner 40 calculates allocation information on the basis of the command values that have been set, and learns the allocation information in association with the command value-related information. Then, when the functionality of automatic operation allocation is used, the allocation information is determined using the command value-related information and the result of learning at that time. Note that the learning may be performed using, for example, a supervised learning technique such as neural network, or another machine learning technique. Any learning method may be used. For example, a method may be used in which the allocation information based on the command values that have been set and the command value-related information are accumulated in association with each other; a command value associated with the command value-related information is manually determined using the accumulated data to establish a rule in a form of a table or the like; and the established rule is then used as the result of learning.

For example, when the command value-related information includes the frequency of conversation between the operator 4 and the recipient 5, and the allocation information is weighting factors, weighting factors for the communication avatar 33 and the manipulation avatar 34 are determined such that a higher frequency of conversation leads to a higher ratio of allocation to the communication avatar 33. Accordingly, whereas the operator 4 and the recipient 5 make less conversation during a task performed on a heavy object by driving the manipulation avatar 34, an increase in the frequency of conversation between the operator 4 and the recipient 5 after this task is complete causes the ratio of allocation to operation of the manipulation avatar 34 to be gradually increased. Then, when the frequency of conversation between the operator 4 and the recipient 5 reaches or exceeds a certain level, the weighting factor on the manipulation avatar 34 is made zero, thereby causing the manipulation avatar 34 to be automatically turned off.

In the present embodiment, the operation mode is automatically switched from one to another, thereby allowing the operator 4 to operate the communication avatar 33 and the manipulation avatar 34 as a single avatar without being conscious of the operation mode.

Note that although the above example has been described in which the automatic mode determiner 40 is included in place of the operation mode switcher 32 of the remote machine operation system 100 of the first embodiment, the automatic mode determiner 40 may be included in place of the operation mode switcher 32 of the remote machine operation systems 100a, 100b, and 100c of the second, third, and fourth embodiments.

### Sixth Embodiment

A remote machine operation system according to a sixth embodiment will next be described. The remote machine operation system 100 of the present embodiment is configured similarly to the remote machine operation system 100 of the first embodiment. The present embodiment will be described in terms of an operation method that will reduce the operational burden of the operator 4. Components having functionality similar to the functionality of the first embodiment are designated by reference characters the same as corresponding ones of the first embodiment, and duplicate description will be omitted. The following description will primarily describe differences from the first embodiment.

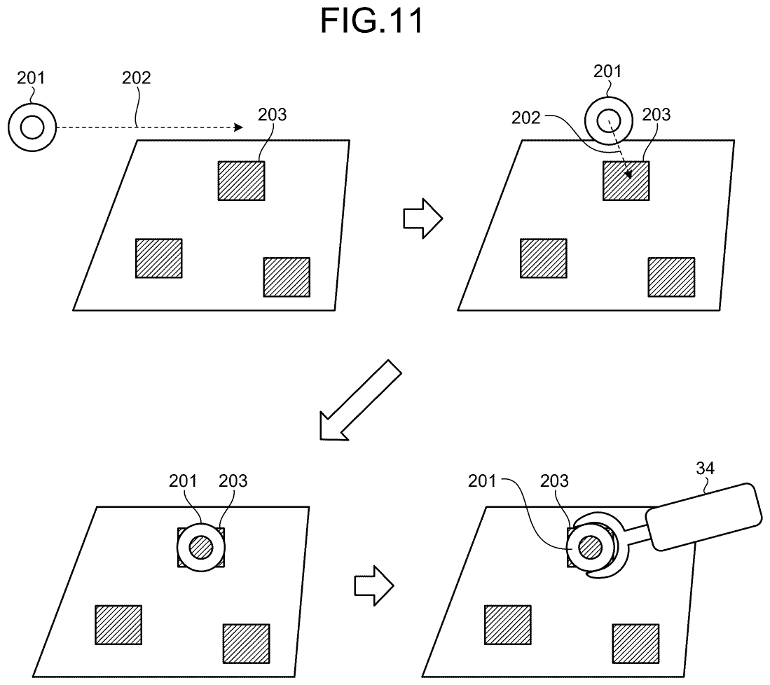

FIG. 11 is a diagram illustrating an example of operation method used by the operator, of the present embodiment. The operator 4 needs to pay attention not to cause the manipulation avatar 34 to hit or come into contact with a nearby object or person during operation of the manipulation avatar 34. This increases the operational load of the operator 4. In the present embodiment, the operation mode further includes a motion specification mode, in which the following operation method is performed. In the motion specification mode, the operator 4 specifies a path before the manipulation avatar 34 moves, thereby enabling the operational load of the operator 4 to be reduced. This can also reduce a risk that the manipulation avatar 34 will hit a nearby object to cause failure. In the present embodiment, the operation interface 1 includes a display device that is enabled to present, to the operator 4, a moving image in which a destination where the manipulation avatar 34 is to reach is superimposed on a moving image showing an area around the augmented avatar 3. The display device may be provided separately from the operation interface 1.
(1) First, as illustrated in the upper images of FIG. 11, the control information generation unit 21 displays, on a display device, a destination 201 of a hand end of the manipulation avatar 34 such that the destination 201 is superimposed on a moving image showing the manipulation avatar 34. The destination 201 is superimposed using, for example, but not limited to, a computer graphics (CG) video or the like. The destination 201 may be displayed using a two-dimensional figure or using a letter. The method of displaying the destination 201 is not limited thereto. In addition, although FIG. 11 illustrates the destination 201 by a moving image of a cylindrical shape, the shape of illustration of the destination 201 is again not limited thereto.
(2) The operator 4 moves the destination 201 using input means such as a joystick, a touch panel, or an eye gaze detection device of the operation interface 1 to thereby specify a moving path 202 of the hand end of the manipulation avatar 34. In the example illustrated in FIG. 11, the operator 4 wants the hand end of the manipulation avatar 34 to reach a target object 203, and therefore specifies the path to the target object 203 by moving the destination 201.
(3) When the operator 4 has moved the destination 201 to the target object 203 as illustrated in the lower left image of FIG. 11, the operator 4 performs, for example, an operation to indicate the end of path specification. This causes the hand end of the manipulation avatar 34 to move to the destination 201 as illustrated in the lower right image of FIG. 11.
(4) When the above automatic control has insufficient accuracy, the operator 4 may remotely control the manipulation avatar 34 for fine adjustment. Note that the operator 4 may intervene during or after automatic control of the manipulation avatar 34, via remote control. For example, when a hit is likely to occur during automatic control of the manipulation avatar 34, the operator 4 may adjust the action of the manipulation avatar 34 via remote control.

As described above, the operation interface 1 receives, from the operator 4, an operation to move the position of the destination 201, and the display device moves the destination 201 displayed on the display device according to the operation received by the operation interface 1. When the operation interface 1 receives an operation to fix the destination 201 from the operator 4, the manipulation avatar 34 starts to move to the destination 201.

In addition, the destination of the manipulation avatar 34 may be set using the communication avatar 33. For example, the communication avatar 33 may be configured to include a device such as a levitation drive device, that enables the communication avatar 33 to move, and an indication device such as a laser pointer, capable of pointing to a position using a real image at a remote location (second location), and the operator 4 may remotely control the communication avatar 33 to specify the destination using the real image. At the end of specification process, the hand end of the manipulation avatar 34 moves to the destination similarly to the foregoing example. That is, the communication avatar 33 may include an indication device capable of pointing to an external position that has been specified, and an operation may be performed in which the operation interface 1 receives an operation to move the destination of the manipulation avatar 34, the indication device points to the destination specified by the operation received by the operation interface 1, and when the operation interface 1 receives an operation to fix the destination from the operator 4, the manipulation avatar 34 starts to move to the destination.

In addition, the operation method of the present embodiment may be used in the remote machine operation systems 100a, 100b, 100c, and 100d described in the second through fifth embodiments.

As described above, in the present embodiment, the operator 4 is enabled to move the manipulation avatar 34 after specifying the destination of the manipulation avatar 34. This can reduce operational burden of the operator 4.

### Seventh Embodiment

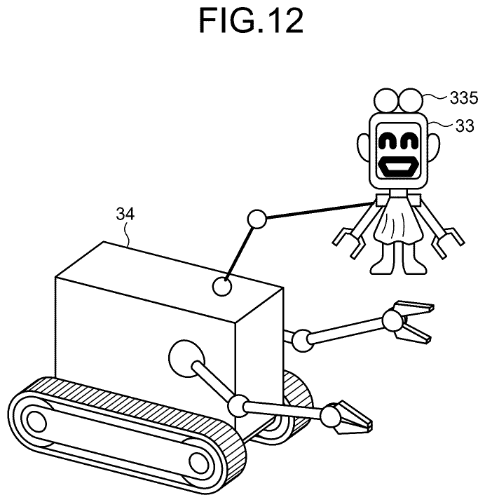

FIG. 12 is a diagram illustrating an exemplary configuration of the augmented avatar 3 according to a seventh embodiment. In the present embodiment, the communication avatar 33 of the augmented avatar 3 can change a relative position thereof to the manipulation avatar 34. In addition, a camera 335 is included in the communication avatar 33 described in the first embodiment. Except these features, the remote machine operation system 100 of the present embodiment is configured similarly to the remote machine operation system 100 of the first embodiment. The following description will primarily describe differences from the first embodiment.

In the example illustrated in FIG. 12, the manipulation avatar 34 is movable, and the communication avatar 33 moves with the manipulation avatar 34. In addition, a drive mechanism such as, for example, an arm that can be driven is provided between the communication avatar 33 and the manipulation avatar 34. That is, the augmented avatar 3 includes a drive mechanism that can change the relative position of the communication avatar 33 to the manipulation avatar 34. This enables the relative position between the communication avatar 33 and the manipulation avatar 34 to be changed as desired, for example, according to an operation of the operator 4. Moreover, a relative orientation of the communication avatar 33 to the manipulation avatar 34 may also be changeable. This can improve expressiveness of the communication avatar 33. Furthermore, the camera 335 installed in the communication avatar 33 enables the operator 4 to see the object to be handled, from a desired viewing position.

Note that although the above example has been described in which the relative position between the communication avatar 33 and the manipulation avatar 34 described in the first embodiment can be changed, and the camera 335 is provided in the communication avatar 33 described in the first embodiment, the configuration is not limited thereto. The relative position between the communication avatar 33 and the manipulation avatar 34 may be changeable and the camera 335 may be provided in the communication avatar 33 similarly in one of the second through sixth embodiments or in a combination of two or more of the first through sixth embodiments.

The configurations described in the foregoing embodiments are merely examples. These configurations may be combined with another known technology, and configurations of different embodiments may be combined together. Moreover, part of such configurations may be omitted and/or modified without departing from the spirit thereof.

Aspects of the present disclosure will be described below collectively as an addendum. Note that the augmented avatar described in the addendum corresponds to the avatar described in the embodiments.

### Supplement 1

An augmented avatar capable of performing a task via remote control, the augmented avatar comprising:
a communication avatar having a body schema; and
a remote machine avatar capable of performing the task via the remote control.

### Supplement 2

The augmented avatar according to supplement 1, wherein
the communication avatar includes
a verbal communication unit to make verbal communication, and
an action representation unit capable of being driven in imitation of at least part of a human or animal body.

### Supplement 3

The augmented avatar according to supplement 1 or 2, wherein
the communication avatar includes
a first monitor enabled to display a first moving image showing an operator who performs the remote control, and
a first camera provided in a rear of the first monitor and enabled to shoot in a direction toward a projection surface of the first monitor, from the rear, and
the first moving image is a moving image obtained by shooting in a direction toward a projection surface of a second monitor by a second camera, the second monitor being enabled to present, to the operator, a second moving image captured by the first camera, the second camera being provided in a rear of the second monitor.

### Supplement 4

The augmented avatar according to any one of supplements 1 to 3, comprising
a status indication device to indicate which one of the communication avatar and the remote machine avatar performs an action.

### Supplement 5

The augmented avatar according to any one of supplements 1 to 4, comprising
a current breaking device to interrupt a current of a drive system in the remote machine avatar when an obstruction is detected at a distance from the augmented avatar, the distance being less than or equal to a threshold.

### Supplement 6

The augmented avatar according to supplement 1, wherein the augmented avatar is foldable to be housed in a container, and becomes operable by expansion.

### Supplement 7

A remote machine operation system comprising:
an operation interface to receive an operation of an operator; and
an augmented avatar capable of performing a task according to the operation received by the operation interface, at a location different from a location where the operator is present, wherein
the augmented avatar includes
a communication avatar having a body schema, and
a remote machine avatar capable of performing the task via remote control.

### Supplement 8

The remote machine operation system according to supplement 7, comprising
a display device enabled to present, to the operator, a moving image in which a destination is superimposed on a moving image showing an area around the augmented avatar, the destination being a location where the remote machine avatar is to reach, wherein
the operation interface receives, from the operator, an operation to move a position of the destination,
the display device moves the destination displayed on the display device according to the operation received by the operation interface, and
when the operation interface receives an operation to fix the destination from the operator, the remote machine avatar starts to move to the destination.

### Supplement 9

The remote machine operation system according to supplement 7, wherein
the communication avatar includes an indication device capable of pointing to an external position that has been specified,
the operation interface receives an operation to move a destination of the remote machine avatar,
the indication device points to the destination received by the operation interface, and
when the operation interface receives an operation to fix the destination from the operator, the remote machine avatar starts to move to the destination.

### REFERENCE SIGNS LIST

1 operation interface; 2 control device; 3, 3a, 3b, 3c, 3d augmented avatar; 11, 36, 341, 335 camera; 21 control information generation unit; 22, 31 communication unit; 32 operation mode switcher; 33 communication avatar; 34 manipulation avatar; 37 avatar status indication device; 37-1, 37-2 indicator; 38 detection sensor; 39 current breaking device; 40 automatic mode determiner; 100, 100a, 100b, 100c, 100d remote machine operation system; 331 microphone; 332 display unit; 333 speaker; 334 action representation unit; 342 drive control unit; 343 driven unit.

1. An avatar capable of performing an action via remote control, the avatar comprising:
a communication avatar having a body schema to communicate with a recipient through control of the body schema via the remote control, at least part of the body schema being driven; and
a remote machine avatar including a driven unit other than the body schema, the remote machine avatar being capable of performing a task through control of the driven unit via the remote control.

2. The avatar according to claim 1, wherein
the communication avatar includes
a verbal communication unit to make verbal communication, and
an action representation unit capable of being driven in imitation of at least part of a human or animal body.

3. The avatar according to claim 1, wherein
the communication avatar includes
a first monitor enabled to display a first moving image showing an operator who performs the remote control, and
a first camera provided in a rear of the first monitor and enabled to shoot in a direction toward a projection surface of the first monitor, from the rear, and the first moving image is a moving image obtained by shooting in a direction toward a projection surface of a second monitor by a second camera, the second monitor being enabled to present, to the operator, a second moving image captured by the first camera, the second camera being provided in a rear of the second monitor.

4. The avatar according to claim 1, comprising
a status indication device to indicate which one of the communication avatar and the remote machine avatar performs an action.

5. The avatar according to claim 1 4, comprising
a current breaking device to interrupt a current of a drive system in the remote machine avatar when an obstruction is detected at a distance from the avatar, the distance being less than or equal to a threshold.

6. The avatar according to claim 1, wherein the avatar is foldable to be housed in a container, and becomes operable by expansion.

7. The avatar according to claim 1, wherein at least one of color or clothing of the communication avatar is changeable by changing a moving image to be displayed on the communication avatar.

8. The avatar according to claim 1, wherein at least one of words said by the avatar, a travel direction of the avatar, or a document provided by the avatar is projected onto an area near the avatar.

9. The avatar according to claim 1, comprising
an operation allocation device to allocate an operation of an operator who performs the remote control to a command value directed to either the communication avatar or the remote machine avatar.

10. The avatar according to claim 1, comprising
a drive mechanism capable of changing a relative position of the communication avatar to the remote machine avatar.

11. A remote machine operation system comprising:
an operation interface to receive an operation of an operator; and
an avatar capable of performing an action according to the operation received by the operation interface, at a location different from a location where the operator is present, wherein
the avatar includes
a communication avatar having a body schema to communicate with a recipient through control of the body schema via remote control, at least part of the body schema being driven, and
a remote machine avatar including a driven unit other than the body schema, the remote machine avatar being capable of performing a task through control of the driven unit via remote control.

12. The remote machine operation system according to claim 11, comprising
a display device enabled to present, to the operator, a moving image in which a destination is superimposed on a moving image showing an area around the avatar, the destination being a location where the remote machine avatar is to reach, wherein
the operation interface receives, from the operator, an operation to move a position of the destination,
the display device moves the destination displayed on the display device according to the operation received by the operation interface, and
when the operation interface receives an operation to fix the destination from the operator, the remote machine avatar starts to move to the destination.

13. The remote machine operation system according to claim 11, wherein
the communication avatar includes an indication device capable of pointing to an external position that has been specified,
the operation interface receives an operation to move a destination of the remote machine avatar,
the indication device points to the destination received by the operation interface, and
when the operation interface receives an operation to fix the destination from the operator, the remote machine avatar starts to move to the destination.
